(19) United States
(12) Patent Application Publication
(10) Pub. No.: US 2026/0212072 A1
(43) Pub. Date: Jul. 23, 2026

(54) CYBER-PHYSICAL ORCHESTRATION SYSTEM FOR EXECUTION-STATE COHERENCE AND PROBABILISTIC STABILITY QUANTIFICATION OF DISTRIBUTED ASSETS

(71) Applicant: Zohar Dor Lavi, Zurich (CH)

(72) Inventor: Zohar Dor Lavi, Zurich (CH)

(21) Appl. No.: 19/438,586

(22) Filed: Jan. 1, 2026

Related U.S. Application Data
(63) Continuation-in-part of application No. 19/230,103, filed on Jun. 6, 2025.
(63) Continuation-in-part of application No. 19/047,727, filed on Feb. 7, 2025.

(30) Foreign Application Priority Data
Jan. 20, 2025 (CH) CH000053/2025
Jun. 6, 2025 (CH) CH000615/2025

(51) Int. Cl. G06F 30/20; G06F 111/04

(52) U.S. Cl. CPC G06F 30/20; G06F 2111/04

(57) ABSTRACT

A cyber-physical orchestration system for maintaining execution-state coherence and probabilistic stability quantification of distributed assets is disclosed. The system includes a telemetry ingestion layer and a temporal normalization engine configured to transform asynchronous signals from disparate data-generation environments into a normalized execution-state vector (V) aligned to a unified reference timebase. A synchronous state-management data-bus maintains a digital twin comprising structural, temporal progression, and resource-allocation state planes. A probabilistic state-evaluation engine applies a stochastic model to deviations between the execution-state vector (V) and an expected execution trajectory to compute a bounded stability coefficient. When the stability coefficient exceeds a predefined threshold, a control actuation module enforces deterministic system-level constraints on the resource-allocation state plane, transitioning the digital twin into a protected execution state that programmatically constrains further resource modification.

### CROSS-REFERENCE TO RELATED APPLICATIONS

This application is a continuation-in-part of U.S. patent application Ser. No. 19/047,727, filed Feb. 7, 2025 (published as US 2025/0292342A1), and U.S. patent application Ser. No. 19/230,103, filed Jun. 6, 2025 (published as US 2025/0378511A1). This application further claims foreign priority under 35 U.S.C. Section 119 to Swiss Patent Application No. CH000053/2025 (granted as CH 721679), and Swiss Patent Application No. CH000615/2025 (granted as CH721888). The entire disclosures of each of the aforementioned applications are incorporated herein by reference.

### TECHNICAL FIELD

The present invention relates generally to cyber-physical systems and distributed state management. More specifically, the invention relates to a deterministic state-machine architecture for managing resource-intensive missions by normalizing asynchronous operational telemetry into a synchronous governance framework. Under “distributed assets,” this invention specifically contemplates technically monitored physical or digital systems with associated resource-allocation protocols.

### BACKGROUND OF THE INVENTION

In complex mission-critical environments, such as aerospace manufacturing, pharmaceutical research and development, and sovereign infrastructure development, data is generated by disparate, uncoordinated systems. This creates a technical problem of “Execution Opacity” resulting from asynchronous sampling rates, inconsistent data schemas, and varied temporal reference frames across distributed environments.

Traditional project governance systems are reactive and rely on human intermediaries who constitute a single point of failure. These human-centric systems are incapable of resolving inconsistencies arising from latency or out-of-order events in real-time. There exists a technical necessity for an active state-machine capable of ingestive normalization and deterministic actuation to maintain systemic stability and ensure execution-state coherence.

### SUMMARY OF THE INVENTION

The present invention provides a technical solution to the problem of information asymmetry and operational latency. By transforming asynchronous real-world signals into a normalized execution-state vector, the architecture maintains a high-fidelity digital twin. A stability coefficient is computed via a probabilistic state-evaluation engine to represent a projected likelihood of mission failure.

Upon reaching a predefined failure threshold, a control actuation module enforces an irreversible state change to protect governed resources. This technical stability quantification establishes a machine-verifiable proof of execution, enabling assets to meet rigorous criteria for institutional insurability and bank-backed credit enhancement.

### DETAILED DESCRIPTION OF THE INVENTION

The system comprises a telemetry ingestion layer configured to receive asynchronous signals from a plurality of data-generation environments, such as building information modeling (BIM) sensors, software repositories, and IoT units. A temporal normalization engine performs a computational alignment of incoming signals by mapping them to a unified reference timebase, resolving data-packet latency or out-of-order events via sliding-window interpolation based on historical state-vector velocity.

This process generates a normalized execution-state vector (V), which is ingested by a synchronous state-management data-bus. The data-bus maintains a digital twin organized into three interdependent planes: a structural state plane (e.g., 3D/BIM configuration), a temporal progression state plane (e.g., 4D roadmap), and a resource-allocation state plane (e.g., 5D cost and disbursement protocol). The data-bus may be implemented on a distributed or append-only ledger to ensure the immutability of state transitions.

A probabilistic state-evaluation engine calculates a stability coefficient by applying a stochastic model to the delta between the real-time execution-state vector (V) and the temporal progression plane. The engine may implement a multi-threshold regime: a first threshold for advisory alerts; a second threshold for forensic telemetry audits comprising automated data replay; and a third threshold for deterministic actuation.

When this coefficient exceeds a predefined threshold, a control actuation module enforces a deterministic system-level constraint, transitioning the digital twin into a protected execution state. In this state, the resource-allocation plane is programmatically locked, and the system may trigger a state-synchronized update with an external financial transaction system via an ISO 20022 compliant interface or initiate an atomic swap capital recovery protocol. Data-generation environments or actors may further be authenticated using identity-verification protocols (KYC) to ensure authority within the ecosystem.

What is claimed is:

1. (canceled)

2. (canceled)

3. (canceled)

4. (canceled)

5. A cyber-physical execution-state control system for maintaining execution-state coherence of a governed asset, wherein the governed asset comprises a physically or digitally monitored resource-intensive system having associated resource-allocation protocols, the system comprising:
a telemetry ingestion layer configured to receive asynchronous telemetry signals from a plurality of heterogeneous data-generation environments associated with the governed asset, wherein the heterogeneous data-generation environments are operationally independent and lack a shared native synchronization protocol, and wherein the asynchronous telemetry signals have differing sampling rates, inconsistent data schemas, or varied temporal reference frames;
a temporal normalization engine configured to:
(i) map the asynchronous telemetry signals to a unified reference timebase;
(ii) resolve latency conditions or out-of-order signal conditions among the asynchronous telemetry signals;
(iii) apply sliding-window interpolation based on historical state-vector velocity to reconstruct missing or delayed telemetry values; and
(iv) generate a normalized execution-state vector V representing a current operational state of the governed asset;
a synchronous state-management data-bus configured to maintain a digital twin of the governed asset, the digital twin comprising:
(i) a structural state plane representing physical or logical configuration data of the governed asset;
(ii) a temporal progression state plane representing milestone definitions, expected completion states, expected execution trajectories, or authorized sequential dependencies; and
(iii) a resource-allocation state plane representing resource commitments, disbursement rules, collateral obligations, recovery rules, or a combination thereof associated with the governed asset;
wherein state transitions of the digital twin are recorded in an append-only data structure;
a probabilistic state-evaluation engine configured to compute a bounded stability coefficient S by applying a stochastic model configured to generate a bounded probabilistic estimate of execution failure likelihood from temporal deviations between the normalized execution-state vector V and an expected execution trajectory represented in the temporal progression state plane;
a threshold evaluation module configured to compare the bounded stability coefficient S against a plurality of predefined thresholds comprising at least an advisory threshold, a forensic reconstruction threshold, and a deterministic actuation threshold; and
a control actuation module configured, when the bounded stability coefficient S satisfies the deterministic actuation threshold, to transition the digital twin into a protected execution state in which at least one modification to the resource-allocation state plane is programmatically constrained based on the bounded stability coefficient S;
wherein the protected execution state generates a machine-enforced state transition that prevents inconsistent modification of the resource-allocation state plane while preserving a machine-verifiable record of the telemetry-derived state condition that caused the protected execution state.

6. The system of claim 5, wherein the temporal normalization engine dynamically adjusts a window size W of the sliding-window interpolation based on variance in observed state-vector velocity across the plurality of heterogeneous data-generation environments.

7. The system of claim 5, wherein the temporal normalization engine resequences out-of-order telemetry signals by reference to timestamp data associated with the asynchronous telemetry signals before generating the normalized execution-state vector V.

8. The system of claim 5, wherein the temporal normalization engine generates the normalized execution-state vector V by aligning telemetry-derived state values from at least two independent data-generation environments to the unified reference timebase.

9. The system of claim 5, wherein the append-only data structure comprises a distributed ledger configured to store cryptographically linked records of state transitions of the structural state plane, the temporal progression state plane, and the resource-allocation state plane.

10. The system of claim 5, wherein the stochastic model comprises at least one of a Kalman filter, a Monte Carlo simulation model, or a Bayesian inference model configured to estimate execution instability from deviations between the normalized execution-state vector V and the expected execution trajectory.

11. The system of claim 5, wherein the advisory threshold triggers transmission of an advisory notification, the forensic reconstruction threshold triggers automated reconstruction of execution-state history from the append-only data structure, and the deterministic actuation threshold triggers transition of the digital twin into the protected execution state.

12. The system of claim 5, wherein the control actuation module programmatically prevents execution of a resource-modification instruction while the digital twin remains in the protected execution state.

13. The system of claim 12, wherein the resource-modification instruction comprises at least one of a disbursement instruction, a collateral-modification instruction, a recovery instruction, a resource-state update instruction, or a physical resource-access authorization instruction associated with the resource-allocation state plane.

14. The system of claim 5, further comprising an identity governance module configured to authenticate at least one data-generation environment or actor before permitting a write operation to the synchronous state-management data-bus.

15. The system of claim 14, wherein the identity governance module is configured to generate a cryptographic identity token binding an authenticated data-generation environment or actor to at least one state transition recorded in the append-only data structure.

16. The system of claim 5, further comprising a financial interface module configured to transmit a state-synchronized resource-allocation message to an external financial transaction system upon transition of the digital twin into the protected execution state.

17. The system of claim 16, wherein the state-synchronized resource-allocation message is formatted according to an ISO 20022 compliant messaging protocol.

18. The system of claim 16, wherein the financial interface module is configured to initiate an atomic capital recovery protocol via an ISO 20022 compliant messaging interface upon transition of the digital twin into the protected execution state, the atomic capital recovery protocol being configured to execute or reject a plurality of recovery transactions as a single indivisible operation.

19. The system of claim 5, wherein the governed asset comprises a real estate development project, wherein the structural state plane comprises building information modeling data, the temporal progression state plane comprises construction milestone data, and the resource-allocation state plane comprises a staged capital disbursement protocol.

20. The system of claim 19, wherein the control actuation module prevents release of a staged capital disbursement unless milestone completion data received from one or more Internet of Things construction monitoring devices having authenticated device identifiers satisfies predefined milestone completion criteria represented in the temporal progression state plane.

21. The system of claim 19, wherein the probabilistic state-evaluation engine computes the bounded stability coefficient S from deviations between Internet of Things verified construction progress and expected construction milestone progression represented in the temporal progression state plane.

22. A computer-implemented method for cyber-physical execution-state control of a governed asset, comprising:
receiving asynchronous telemetry signals from a plurality of heterogeneous data-generation environments associated with the governed asset, wherein the heterogeneous data-generation environments are operationally independent and lack a shared native synchronization protocol, and wherein the asynchronous telemetry signals have differing sampling rates, inconsistent data schemas, or varied temporal reference frames;
mapping the asynchronous telemetry signals to a unified reference timebase;
resolving latency conditions or out-of-order signal conditions among the asynchronous telemetry signals;
applying sliding-window interpolation based on historical state-vector velocity to reconstruct missing or delayed telemetry values;
generating a normalized execution-state vector V representing a current operational state of the governed asset;
maintaining, by a synchronous state-management data-bus, a digital twin comprising a structural state plane, a temporal progression state plane, and a resource-allocation state plane;
recording state transitions of the digital twin in an append-only data structure;
computing a bounded stability coefficient S by applying a stochastic model to a deviation between the normalized execution-state vector V and an expected execution trajectory represented in the temporal progression state plane;
comparing the bounded stability coefficient S against a deterministic actuation threshold; and
when the bounded stability coefficient S satisfies the deterministic actuation threshold, transitioning the digital twin into a protected execution state in which at least one modification to the resource-allocation state plane is programmatically constrained based on the bounded stability coefficient S.

23. A non-transitory computer-readable medium storing instructions that, when executed by one or more processors, cause the one or more processors to perform operations comprising:
receiving asynchronous telemetry signals from a plurality of heterogeneous data-generation environments associated with a governed asset, wherein the heterogeneous data-generation environments are operationally independent and lack a shared native synchronization protocol, and wherein the asynchronous telemetry signals have differing sampling rates, inconsistent data schemas, or varied temporal reference frames;
mapping the asynchronous telemetry signals to a unified reference timebase;
resolving latency conditions or out-of-order signal conditions among the asynchronous telemetry signals;
applying sliding-window interpolation based on historical state-vector velocity to reconstruct missing or delayed telemetry values;
generating a normalized execution-state vector V representing a current operational state of the governed asset;
maintaining a digital twin comprising a structural state plane, a temporal progression state plane, and a resource-allocation state plane;
computing a bounded stability coefficient S by applying a stochastic model to a deviation between the normalized execution-state vector V and an expected execution trajectory represented in the temporal progression state plane; and
when the bounded stability coefficient S satisfies a deterministic actuation threshold, transitioning the digital twin into a protected execution state in which at least one modification to the resource-allocation state plane is programmatically constrained based on the bounded stability coefficient S.

24. The system of claim 5, further comprising a certificate generation module configured to generate a machine-verifiable proof-of-execution record comprising the normalized execution-state vector V, the bounded stability coefficient S, one or more threshold events, and one or more protected execution-state transitions, wherein the machine-verifiable proof-of-execution record is formatted for transmission to an institutional underwriting, audit, credit, or regulatory reporting system.
